(19) United States
(12) Patent Application Publication
(10) Pub. No.: US 2021/0226751 A1
(43) Pub. Date: Jul. 22, 2021

(54) SERVING CELL WITH DISTINCT PCI INDEX PER RRH FOR DL TCI STATE, SPATIAL RELATION, AND UL TCI STATE

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 17/149,539

(22) Filed: Jan. 14, 2021

Related U.S. Application Data
(60) Provisional application No. 62/962,892, filed on Jan. 17, 2020.

(51) Int. Cl. H04L 5/00; H04W 56/00; H04W 72/04

(52) U.S. Cl. CPC H04L 5/0048; H04W 36/30; H04W 72/0413; H04W 56/001

(57) ABSTRACT

Aspects of the disclosure relate to Layer 1/Layer 2-centric inter-cell mobility. Within a serving cell having a plurality of remote radio heads, each remote radio head transmits a referenced signal that includes a PCI index unique to the remote radio head. A user equipment is configured with a beam management function that uses one of the reference signals as a source reference signal for the beam management. The source reference signal is uniquely tied to the corresponding remote radio head through its PCI index.

### CROSS REFERENCE TO RELATED APPLICATION

The present application claims priority to U.S. Provisional Patent Application No. 62/962,892, filed Jan. 17, 2020, which is hereby incorporated by reference in its entirety.

### TECHNICAL FIELD

The technology discussed below relates generally to wireless communication systems, and more particularly, to wireless communication in a serving cell with a distinct physical cell identity (PCI) index for each remote radio head (RRH).

### INTRODUCTION

Wireless technologies and standards such as the evolving 3GPP 5G New Radio (NR) standard that specifies frequency transmission waveforms and protocols, as well as the use of multiple transmission/reception points (multi-TRP) have been proposed. Furthermore, 5G NR standards continue to provide enhancements for multi-beam operation, particularly for high frequency transmissions (e.g., frequency range FR2, which encompass approximately 6 GHz and above), as well as for multi-TRP deployments. Some further enhancements in 5G NR include improving inter-cell mobility, which is a procedure that ensures that a wireless user equipment (UE) is able to change or hand-off from one wireless cell to another wireless cell such as whenever the UE detects an adjacent wireless cell with higher signal quality.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In accordance with a first aspect of the disclosure, a method is provided that includes: for a serving cell including a first remote radio head (RRH) and a second RRH, transmitting from the first RRH to a user equipment a first reference signal that includes a first PCI index for identifying the first RRH and a first reference signal (RS) resource ID; and transmitting from the second RRH to the user equipment a second reference signal that includes a second PCI index for identifying the second RRH and a second RS resource ID.

In accordance with a second aspect of the disclosure, a base station is provided that includes: a processor configured to: command a first RRH in a serving cell to transmit a first reference signal (RS) to a user equipment that includes a first PCI index for identifying the first RRH and a first RS resource ID; and command a second RRH in the serving cell to transmit a second reference signal to the user equipment that includes a second PCI index for identifying the second RRH and a second RS resource ID.

In accordance with a third aspect of the disclosure, a method is provided that includes: receiving at a user equipment (UE) a first reference signal (RS) from a first remote radio head (RRH) in a serving cell, wherein the first reference signal includes a PCI index for identifying the first RRH and includes a first RS resource ID; and receiving at the UE a second RS from a second RRH in the serving cell, wherein the second RS includes a second PCI index for identifying the second RRH and includes a second RS resource ID.

In accordance with a fourth aspect of the disclosure, a user equipment is provided that includes: a transceiver configured to receive a first reference signal (RS) from a first remote radio head (RRH) in a serving cell, wherein the first reference signal includes a PCI index for identifying the first RRH and includes a first RS resource ID; and receive a second RS from a second RRH in the serving cell, wherein the second RS includes a second PCI index for identifying the second RRH and includes a second RS resource ID.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a conceptual illustration of an example of a radio access network according to some aspects of the disclosure.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some embodiments.

FIG. 5 illustrates a radio protocol architecture for a UE and/or gNB in which the disclosed aspects are operable.

FIG. 6 is a process diagram for a message exchange between an RRH and a user equipment in accordance with an aspect of the disclosure.

FIG. 7 is a block diagram conceptually illustrating an example of a hardware implementation of a base station according to some aspects of the disclosure.

FIG. 8 is a block diagram conceptually illustrating an example of a hardware implementation of a UE according to some aspects of the disclosure.

FIG. 9 is a diagram of an example RRC message that establishes a spatial relationship between a reference signal in a PUCCH and a source reference signal from an RRH beam as identified through a beam index and a PCI index in accordance with an aspect of the disclosure.

FIG. 10 is a diagram of an example medium access control (MAC) control element (CE) message that establishes a spatial relationship for user equipment in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Of note, for 5G NR systems inter-cell mobility may be configured to be layer 1 (i.e., the L1 or PHY layer) or layer 2 (i.e., the L2 or MAC layer) centric (i.e., L1/L2-centric). It is noted that within the 5G NR framework, various operation modes for inter-cell mobility such L1/L2-centric inter-cell mobility may be possible for different operational scenarios as will be further described herein. Additionally, the following definitions are provided for terminology that may be used within this disclosure.

### Definitions

RAT: radio access technology. The type of technology or communication standard utilized for radio access and communication over a wireless air interface. Just a few examples of RATs include GSM, U IRA, E-UTRA (LTE), Bluetooth, and Wi-Fi.

NR: new radio. Generally refers to 5G technologies and the new radio access technology undergoing definition and standardization by 3GPP in Release 15.

Legacy compatibility: may refer to the capability of a 5G network to provide connectivity to pre-5G devices, and the capability of 5G devices to obtain connectivity to a pre-5G network.

Multimode device: a device that can provide simultaneous connectivity across different networks, such as 5G, 4G, and Wi-Fi networks.

CA: carrier aggregation. 5G networks may provide for aggregation of sub-6 GHz carriers, above-6 GHz carriers, mmWave carriers, etc., all controlled by a single integrated MAC layer.

MR-AN: multi-RAT radio access network. A single radio access network may provide one or more cells for each of a plurality of RATs, and may support inter- and intra-RAT mobility and aggregation.

MR-CN: multi-RAT core network. A single, common core network may support multiple RATs (e.g., 5G, LTE, and WLAN). In some examples, a single 5G control plane may support the user planes of a plurality of RATs by utilizing software-defined networking (SDN) technology in the core network.

SDN: software-defined networking. A dynamic, adaptable network architecture that may be managed by way of abstraction of various lower-level functions of a network, enabling the control of network functions to be directly programmable.

SDR: software-defined radio. A dynamic, adaptable radio architecture where many signal processing components of a radio such as amplifiers, modulators, demodulators, etc. are replaced by software functions. SDR enables a single radio device to communicate utilizing different and diverse waveforms and RATs simply by reprogramming the device.

mmWave: millimeter-wave. Generally refers to high frequency bands above 24 GHz, which can provide a very large bandwidth.

Beamforming: directional signal transmission or reception. For a beamformed transmission, the amplitude and phase of each antenna in an array of antennas may be precoded, or controlled to create a desired (e.g., directional) pattern of constructive and destructive interference in the wavefront.

MIMO: multiple-input multiple-output. MIMO is a multi-antenna technology that exploits multipath signal propagation so that the information-carrying capacity of a wireless link can be multiplied by using multiple antennas at the transmitter and receiver to send multiple simultaneous streams. At the multi-antenna transmitter, a suitable precoding algorithm (scaling the respective streams' amplitude and phase) is applied (in some examples, based on known channel state information). At the multi-antenna receiver, the different spatial signatures of the respective streams (and, in some examples, known channel state information) can enable the separation of these streams from one another.
1. In single-user MIMO, the transmitter sends one or more streams to the same receiver, taking advantage of capacity gains associated with using multiple Tx, Rx antennas in rich scattering environments where channel variations can be tracked.
2. The receiver may track these channel variations and provide corresponding feedback to the transmitter. This feedback may include channel quality information (CQI), the number of preferred data streams (e.g., rate control, a rank indicator (RI)), and a precoding matrix index (PMI).

Massive MIMO: a MIMO system with a very large number of antennas (e.g., greater than an 8×8 array).

MU-MIMO: a multi-antenna technology where base station, in communication with a large number of UEs, can exploit multipath signal propagation to increase overall network capacity by increasing throughput and spectral efficiency, and reducing the required transmission energy. The transmitter may attempt to increase the capacity by transmitting to multiple users using its multiple transmit antennas at the same time, and also using the same allocated time-frequency resources. The receiver may transmit feedback including a quantized version of the channel so that the transmitter can schedule the receivers with good channel separation. The transmitted data is precoded to maximize throughput for users and minimize inter-user interference.

AS: access stratum. A functional grouping consisting of the parts in the radio access network and in the UE, and the protocols between these parts being specific to the access technique (i.e., the way the specific physical medium between the UE and the radio access network is used to carry information).

NAS: non-access stratum. Protocols between UE and the core network that are not terminated in the radio access network.

RAB: radio access bearer. The service that the access stratum provides to the non-access stratum for transfer of user information between a UE and the core network.

Network slicing: a wireless communication network may be separated into a plurality of virtual service networks (VSNs), or network slices, which are separately configured to better suit the needs of different types of services. Some wireless communication networks may be separated, e.g., according to eMBB, IoT, and ultra-reliable low-latency communication (URLLC) services.

eMBB: enhanced mobile broadband. Generally, eMBB refers to the continued progression of improvements to existing broadband wireless communication technologies such as LTE. eMBB provides for (generally continuous) increases in data rates and increased network capacity.

IoT: the Internet of things. In general, this refers to the convergence of numerous technologies with diverse use cases into a single, common infrastructure. Most discussions of the IoT focus on machine-type communication (MTC) devices.

Duplex: a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and interference cancellation techniques. Full duplex emulation is frequently implemented for wireless links by utilizing frequency division duplex (FDD) or time division duplex (TDD). In FDD, the transmitter and receiver at each endpoint operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction.

OFDM: orthogonal frequency division multiplexing. An air interface may be defined according to a two-dimensional grid of resource elements, defined by separation of resources in frequency by defining a set of closely spaced frequency tones or subcarriers, and separation in time by defining a sequence of symbols having a given duration. By setting the spacing between the tones based on the symbol rate, inter-symbol interference can be eliminated. OFDM channels provide for high data rates by allocating a data stream in a parallel manner across multiple subcarriers.

CP: cyclic prefix. A multipath environment degrades the orthogonality between subcarriers because symbols received from reflected or delayed paths may overlap into the following symbol. A CP addresses this problem by copying the tail of each symbol and pasting it onto the front of the OFDM symbol. In this way, any multipath components from a previous symbol fall within the effective guard time at the start of each symbol, and can be discarded.

Scalable numerology: in OFDM, to maintain orthogonality of the subcarriers or tones, the subcarrier spacing is equal to the inverse of the symbol period. A scalable numerology refers to the capability of the network to select different subcarrier spacings, and accordingly, with each spacing, to select the corresponding symbol period. The symbol period should be short enough that the channel does not significantly vary over each period, in order to preserve orthogonality and limit inter-subcarrier interference.

RSMA: resource spread multiple access. A non-orthogonal multiple access scheme generally characterized by small, grantless data bursts in the uplink where signaling over head is a key issue, e.g., for IoT.

QoS: quality of service. The collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service.

RRH: remote radio head (also called a remote radio unit (RRU). A remote radio transceiver that connects to an operator radio control panel. An RRH contains a base station's RF circuitry plus analog-to-digital/digital-to-analog converters and up/down converters. RRHs also have operation and management processing capabilities and an interface to connect to the rest of the base station.

RSRP: reference signal receive power. The linear average over the power contributions of resource elements (REs) that carry cell-specific reference signals within a considered measurement frequency bandwidth.

DCI: downlink control indicator. A set of information transmitted at the L1 Layer that, among other things, schedules the downlink data channel (e.g., PDSCH) or the uplink data channel (e.g., PUSCH).

MAC-CE: medium access control-control element. A MAC structure used for carrying MAC layer control information between a gNB and a UE. The structure may be implemented as a special bit string in a logical channel ID (LCID) field of a MAC Header.

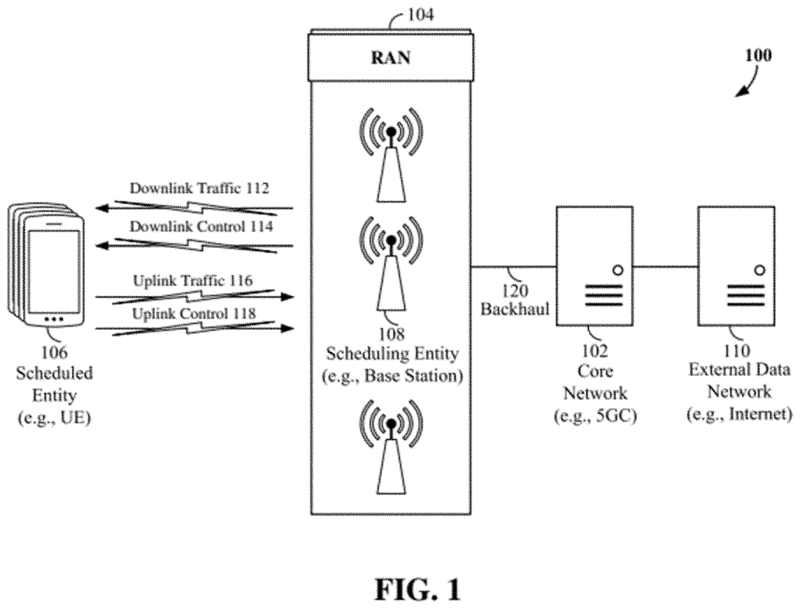

Turning to the drawings, the various concepts presented throughout this disclosure may be implemented across a broad variety of telecommunication systems, network architectures, and communication standards. Referring to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a scheduling entity (e.g., base station 108) to one or more UEs (e.g., UE 106) may be referred to as downlink (DL) transmissions. In accordance with certain aspects of the present disclosure, the term downlink may refer to a point-to-multipoint transmission originating at a network node such as a remote radio head (described further below). Another way to describe this scheme may be to use the term broadcast channel multiplexing. Transmissions from a scheduled entity (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

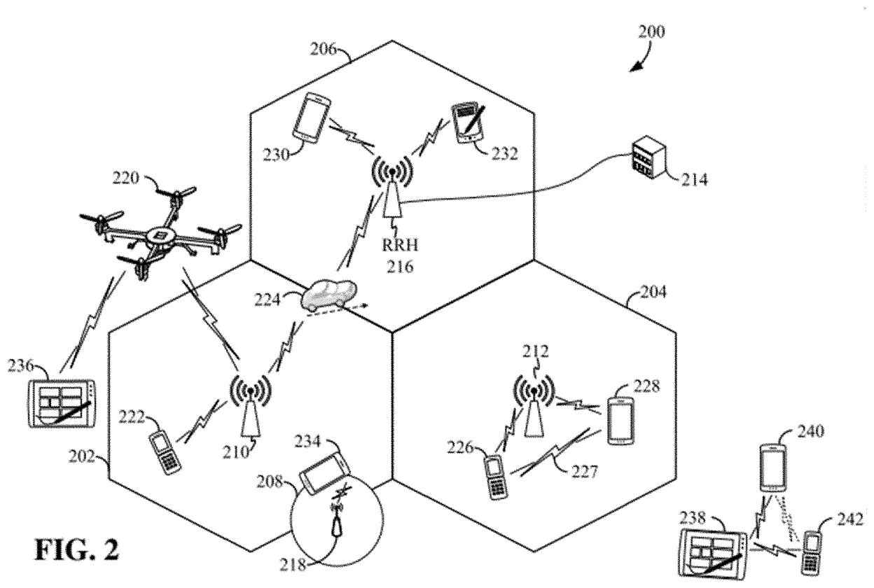

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 (in this case, a base band unit) that is shown controlling a remote radio head (RRH) 216 in cell 206. As defined herein, a base station can have an integrated antenna or may control the signaling of an RRH. RRH 216 includes the RF circuitry such as in base stations 210 and 212 and may interface to base station 214 through an optical fiber using, for example, the Common Public Radio Interface (CPRI) protocol. In the illustrated example, the cells 202, 204, and 206 may be referred to as macrocells, as the base stations 210, 212, and 214 support cells having a relatively large size. Further, a base station 218 is shown in the relatively small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 218 and 214 provide wireless access points to a core network for any number of mobile apparatuses.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 218, and 220 and 214 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In various aspects of the disclosure, a radio access network 200 may utilize DL-based mobility or UL-based mobility to enable mobility and handovers (i.e., the transfer of a UE's connection from one cell to another). In a network configured for DL-based mobility, during a call with a scheduling entity, or at any other time, a UE may monitor various parameters of the signal from its serving cell (the cell providing the radio connection to the UE) as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and RRH 216 may broadcast unified synchronization signals (e.g., unified Primary Synchronization Signals (PSSs), unified Secondary Synchronization Signals (SSSs) and unified Physical Broadcast Channels (PBCH)). These unified synchronization signals may be organized for form a synchronization signal block (SSB). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and RRH 216) within the radio access network 200. Each of the cells may measure a strength of the pilot signal, and the radio access network (e.g., one or more of the base stations 210 and base station 214 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and RRH 216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

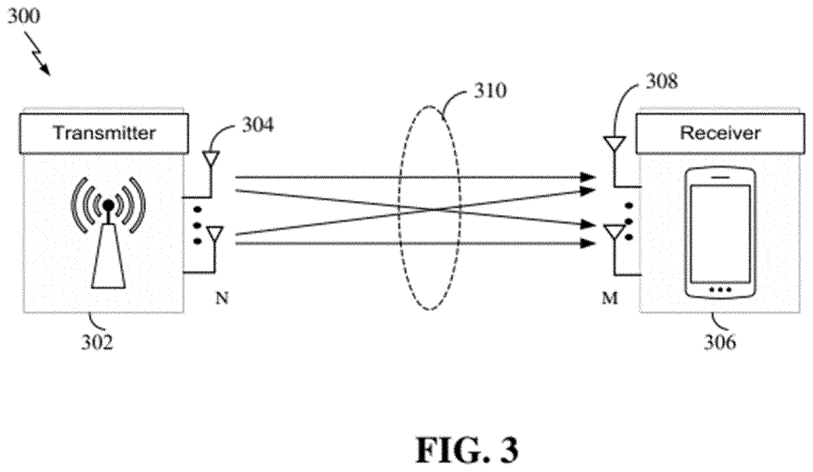

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit a channel-state information reference signal (CSI-RS) with separate channel reference signal (C-RS) sequences for each layer to provide for multi-layer channel estimation. From the CSI-RS, the UE may measure the channel quality across layers and resource blocks and provide the CQI and RI values to the base station for use in updating the rank and assigning REs for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310. The receiver 306 may then reconstruct the data streams using the received signals from each receive antenna 308.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

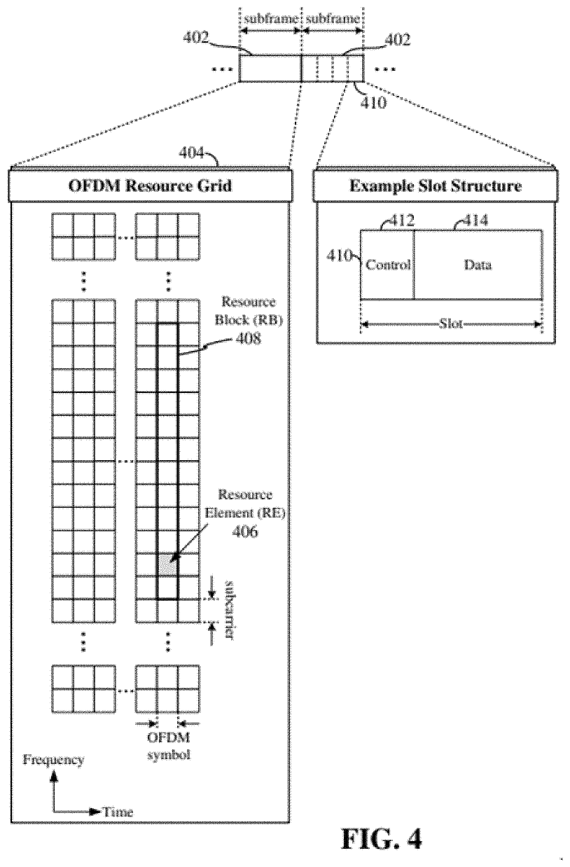

Various aspects of the present disclosure utilize an OFDM waveform, an example of which is schematically illustrated in FIG. 4. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A UE generally utilizes only a subset of the resource grid 404. An RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., the scheduling entity 108) may allocate one or more REs 406 (e.g., within a control region 412) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block (SSB) that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 406 to carry UL control information 118 (UCI). The UCI can originate from higher layers via one or more UL control channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information required for initial cell access, and for acquiring any OSI that may be broadcast periodically or sent on-demand. In some examples, the MSI may be provided over two different downlink channels. For example, the PBCH may carry a master information block (MIB), and the PDSCH may carry a system information block type 1 (SIB1). In the art, SIB1 may be referred to as the remaining minimum system information (RMSI).

OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

Concerning multi-beam operation of the apparatus in FIG. 2, for example, enhancements in 5G NR for multi-beam operation have targeted FR2 frequency bands but are also applicable to the FR1 frequency bands. These enhancements have been provided to facilitate more efficient (i.e., lower latency and overhead) DL/UL beam management to support higher intra-cell and L1/L2-centric inter-cell mobility and a larger number of configured transmission configuration indicator (TCI) states. These enhancements may be implemented by providing a common beam for data and control transmission/reception for DL and UL, especially for intra-band carrier aggregation (CA). Also, enhancements may be engendered with a unified TCI framework for DL and UL beam indication. Further, enhancements concerning signaling mechanisms for these features can improve latency and efficiency through greater usage of dynamic control signaling as opposed to radio resource control (RRC) signaling. Also, enhancements for multi-beam operation may be based on identifying and specifying features to facilitate UL beam selection for UEs equipped with multiple panels, taking into consideration UL coverage loss mitigation due to maximum permissible exposure (MPE) limitations, and based on UL beam indication with the unified TCI framework for UL fast panel selection.

Other enhancements may be for supporting multi-TRP deployment, including targeting both FR1 and FR2 frequency bands. In particular, enhancement may focus on identifying and specifying features to improve reliability and robustness for channels other than PDSCH (i.e., PDCCH, PUSCH, and PUCCH) using multi-TRP or multi-panel with 3GPP Release16 reliability features as the baseline. Additionally, enhancements may concern identifying and specifying QCL/TCI-related enhancements to enable inter-cell multi-TRP operations, assuming multi-DCI based multi-PDSCH reception. Further, beam-management-related enhancements for simultaneous multi-TRP transmission with multi-panel reception may be provided. Still further concerning multi-TRP deployments, enhancements to support high speed train-single frequency network (HST-SFN) deployment scenarios may be provided, such as identifying and specifying solution(s) on QCL assumptions for demodulation reference signal (DMRS) (e.g., multiple QCL assumptions for the same DMRS port(s), targeting DL-only transmissions, or specifying QCL/QCL-like relations (including applicable type(s) and the associated requirement) between DL and UL signals by reusing the unified TCI framework.

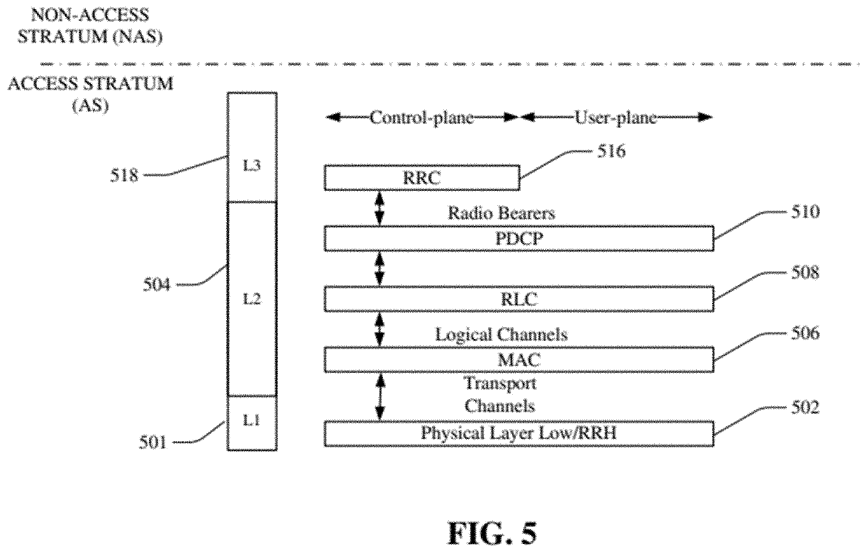

It is further noted that according to certain aspects, the methodology disclosed herein may be implemented at the layer 1 (L1) and layer 2 (L2) levels. Turning now to FIG. 5, a generalized radio protocol architecture for a gNB or a UE, but not limited to such, is shown with three layers: Layer 1, Layer 2, and Layer 3. Layer 1 501 is the lowest layer and implements various physical layer signal processing functions, as well as the remote radio head (RRH) in the case of gNBs. Layer 1 will be referred to herein as the physical layer 502 or PHY layer. Layer 2 (L2 layer) 504 is above the physical layer 501 and is responsible for the link between a UE and a gNB over the physical layer 501.

In the user and control planes, the L2 layer 504 includes a medium access control (MAC) sublayer 506, a radio link control (RLC) sublayer 508, and a packet data convergence protocol (PDCP) 510 sublayer, which are terminated at the eNB on the network side. Although not shown, a gNB or a UE may have several upper layers above the Layer 2 504 including a network layer (e.g., IP layer) on the network side, and an application layer that is terminated at the other end of the connection (e.g., far end UE, server, etc.).

The PDCP sublayer 510 provides multiplexing between different radio bearers and logical channels. The PDCP sublayer 510 also provides header compression for upper layer data packets to reduce radio transmission overhead, security by ciphering the data packets, and handover support for UEs between eNBs. The RLC sublayer 508 provides segmentation and reassembly of upper layer data packets, retransmission of lost data packets, and reordering of data packets to compensate for out-of-order reception due to hybrid automatic repeat request (HARQ). The MAC sublayer 506 provides multiplexing between logical and transport channels. The MAC sublayer 506 is also responsible for allocating the various radio resources (e.g., resource blocks) in one cell among the UEs. The MAC sublayer 506 is also responsible for HARQ operations.

In the control plane, the radio protocol architecture for the UE and gNB may be substantially the same for the physical L1 layer 501 and the L2 layer 504 with the exception that there is no header compression function for the control plane. The control plane may also include a radio resource control (RRC) sublayer 516 in Layer 3 518. The RRC sublayer 516 is responsible for obtaining radio resources (i.e., radio bearers) and for configuring the lower layers using RRC signaling between the gNB and the UE.

As mentioned above, certain enhancements in 5G NR for multi-beam or multi-TRP operations may include L1/L2-centric inter-cell mobility, which may be a MIMO enhancement feature. Thus, the control for effecting UE mobility between cells (e.g., handoffs) is accomplished through controls and/or signaling in the L1 and/or L2 layers rather than at higher layers above the L2 layer; hence being L1/L2 “centric.” According to aspects herein, operational modes or characteristics of this L1/L2-centric inter-cell mobility are disclosed. Broadly, aspects of the present disclosure provide methods and apparatus for operation of inter-cell mobility where at least one serving cell in a communication system are configured with one or more physical cell identity (PCI) indices according to a particular selected mode of operation through the use of either signaling or settings for the physical (PHY) layer or the medium access control (MAC) layer. Further, based on the mode of operation, a remote radio head (RRH) will serve at least one user equipment (UE) based on power information received from at least one UE (e.g., RSRP information).

As disclosed herein, each serving cell can be configured with multiple PCI indices. In this fashion, each RRH of the serving cell can use one PCI index configured for the corresponding serving cell. As used herein, the term “PCI index” will be understood to refer to a unique identifier for an RRH in a serving cell with multiple RRHs. In one embodiment, a PCI index may be synonymous with a PCI. In other implementations, a PCI index may be an encoded version of a PCI. It will be appreciated that the term “PCI index” is functioning as a nonce herein to represent a unique RRH identifier in that it may also be denoted as an SSB set index or an SSB pool index in other implementations. Since each RRH in the serving cell has its own PCI index, each of these nodes may use an identifying index such as an SSB index to identify its antenna beams in multiple antenna beam embodiments. Each antenna beam has its own SSB index. The number of beams (and hence the number of SSB indices) depends upon the transmission frequency. As the frequency increases, the number of possible beams increases. For example, the 5G standard allows for 64 beams in the FR2 spectrum (and hence a full set of 64 corresponding beam indices). The ability for each RRH in a serving cell to have its own PCI index is thus quite advantageous as otherwise the full number of beams could not be used at any given RRH. For example, if a first RRH shares a PCI index with a second RRH, then the first RRH and the second RRH would each have their own unique subset of the possible SSB indices. If a common PCI index were used with the full set of beam indices, then a UE would have no way to distinguish between a first SSB from the first RRH and a second SSB from the second RRH when the second SSB shares the same SSB index as used by the first SSB. As used herein, an SSB index may also be referred to as an SSB identification (SSB ID). Selection of which RRH(s) or corresponding PCI index and/or SSB(s) serves the UE may be accomplished by DCI/MAC-CE and also based on an RSRP per reported SSB ID or per reported PCI.

The unique PCI index for identifying RRHs within a serving cell is not limited to SSBs, but rather may be applied generally to any cell-defining RS, such as CSI-RS or positioning reference signals (PRS), as examples. According to other aspects, it is noted that for the different operational options, DCI/MAC-CE-based cell selection may be applied to only certain cell types. For example, applicable cell types may include any combination of a primary cell (PCell), secondary cells (SCells) and a primary SCell (PSCell). In certain aspects, the DCI/MAC-CE may be configured to only select or deselect SCells or PSCells for the UE, but not the PCell as this is the primary cell.

To provide a L1/L2 mobility between an RRH and other RRHs within a common serving cell, the corresponding SSBs each include a unique PCI index for the node that transmitted the SSB. In one embodiment, the unique PCI index may simply be a PCI. In certain 5G NR implementations, there are 1008 unique PCIs so that the PCI may range from 0 to 1007. More generally, a PCI index as defined herein is an identifier that uniquely identifies the corresponding RRH. In one embodiment as noted earlier, the PCI index may be the PCI. Alternatively, the PCI index is an encoded version of the PCI. For example, if there are just two RRHs in the serving cell with a scheduling entity (e.g., the base station), the PCI index could be a single bit to uniquely identify a particular one of the RRHs. If there are four RRHs in the serving cell, the PCI index could be a two-bit index, and so on. In this fashion, the bandwidth necessary to transmit the PCI index is reduced due to the encoding of the PCI to form the PCI index.

More generally, the RRHs will transmit reference signals (RSs) to the UE that not only include the PCI index but also include a reference signal resource ID (RS resource ID). Should the RS be an SSB, the RS resource ID may be an SSB ID. The PCI index and the SSB ID may be in separate fields in the SSB. Alternatively, the PCI index and the SSB ID may be encoded into a single field or entry in the SSB. Conversely, the RS resource ID may be a CSI-RS resource ID for embodiments in which the RS is a CSI-RS.

The unique PCI index in the RS from an RRH as transmitted to a UE is advantageous for beam management. The beam management may be with respect to a downlink transmission configuration indicator (TCI) state, a spatial relation for the UE, or an uplink TCI state. Regardless of the type of beam management, the RS serves as a source reference signal. For example, in a downlink TCI state for a UE, the source reference signal from an RRH has a QCL relationship with another reference signal from the RRH. Given this QCL relationship, the UE can expect that the reference signal will be transmitted from the RRH over the same antenna beam as used to transmit the source reference signal. The QCL relationship is uniquely established or linked to the source reference signal by the identification of the source reference signal through its PCI index. The QCL relationship may be any one of the QCL Type-A, QCL Type-B, QCL Type-C, or QCL Type-D as defined in the 5G NR protocol. In a spatial relation for the UE, the source reference signal has a spatial relation to a UL message from the UE or a downlink message to the UE. For example, the UE may be configured transmit a PUCCH message using beamforming. The transmission of the PUCCH message may thus be propagated through a particular one of the beams for the UE. A control message such as a RRC signal may configure the UE with the spatial relation between the PUCCH message and whatever beam that the UE received the SSB with. The spatial relationship between the PUCCH message and the SSB is uniquely linked to the SSB through the PCI index carried by the SSB. Given this spatial relation configuration, the UE may then transmit the PUCCH message using the same spatial filter that was used to receive the SSB. Finally, the reference signal from the RRH may serve as a source reference signal for an UL TCI state at the UE that may be uniquely linked to the source reference signal by the PCI index in the source reference signal.

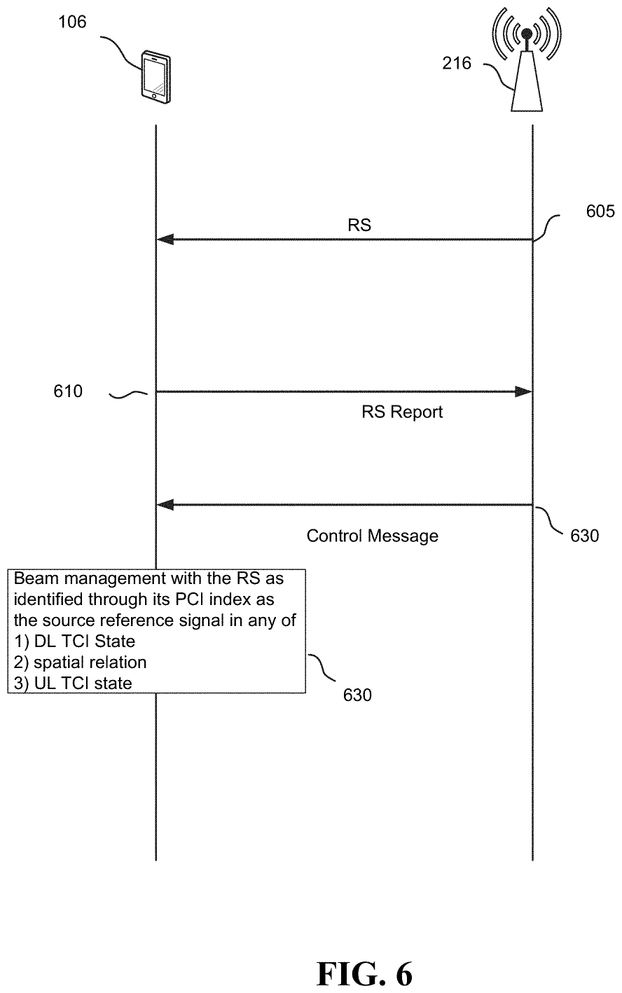

The configuration at an UE of the DL TCI state, the spatial relation, and the UL TCI state may be established by a suitable control message transmitted from an RRH to the UE. In a layer 2 messaging, the control message may be a MAC-CE. In a layer 1 message, the control message may be a CORESET. There are thus two messages from an RRH to the UE with regard to the resulting beam management that may be summarized in the signal flow diagram of FIG. 6. A UE 106 is in a serving cell including an RRH 216 and at least one additional RRH (not illustrated). RRH 216 transmits a RS 605 to UE 106 that includes a PCI index that uniquely identifies RRH 216. UE 106 measures a signal quality of the RS 605 to transmit a signal quality report regarding the measured signal quality of the RS 605. For example, the measured signal quality may be an RSRP value. Based upon the signal quality, a base station (in this case, a base band unit) may then command RRH by transmitting a control signal 630 to use the RS 606 as source reference signal in a beam management relationship. In one implementation, the control message 630 may configure a downlink TCI state for the UE 106. Alternatively (or in addition, the control message 630 may configure a spatial relation for the UE 106. Finally, the control message may configure an uplink TCI state for the UE 106. In all these types of beam management, the reference signal is uniquely tied to the RRH 216 through its PCI index.

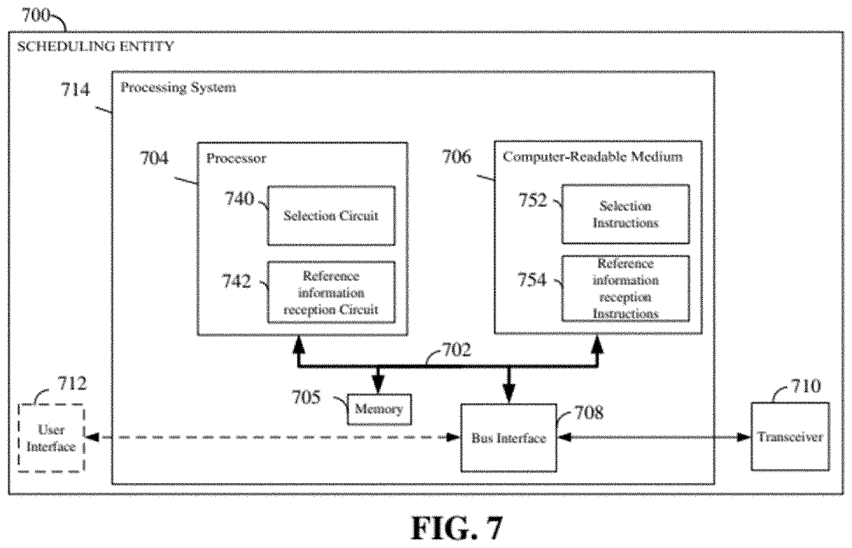

FIG. 7 is a block diagram illustrating an example of a hardware implementation for a scheduling entity 700 employing a processing system 714. For example, the scheduling entity 700 may be a base station or scheduling entity as illustrated in any one or more of FIG. 1, 2, or 3. In another example, the scheduling entity 700 may be a UE acting as scheduling entity as illustrated in any one or more of FIG. 1, 2, or 3.

The scheduling entity 700 may be implemented with a processing system 714 that includes one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 700 may be configured to perform any one or more of the functions described herein. That is, the processor 704, as utilized in a scheduling entity 700, may be used to implement any one or more of the processes and procedures described above and illustrated in FIG. 6.

In this example, the processing system 714 may be implemented with a bus architecture, represented generally by the bus 702. The bus 702 may include any number of interconnecting buses and bridges depending on the specific application of the processing system 714 and the overall design constraints. The bus 702 communicatively couples together various circuits including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art, and therefore, will not be described any further. A bus interface 708 provides an interface between the bus 702 and a transceiver 710 (note that transceiver is conceptual in that the RF circuitry for transceiver 710 is located in an RRH). The transceiver 710 provides a communication interface or means for communicating with various other apparatus over a transmission medium. Depending upon the nature of the apparatus, a user interface 712 (e.g., keypad, display, speaker, microphone, joystick) may also be provided. Of course, such a user interface 712 is optional, and may be omitted in some examples, such as a base station.

In some aspects of the disclosure, the processor 704 may include selection circuitry 740 configured for various functions, including, for example, selection of either an RRH, PCI, or at least one serving cell for serving a UE in an L1/L2-centric inter-cell mobility system. In further aspects, the processor may include reference information receiving circuitry 742 configured for various functions, including, for example, receiving reference information from a UE concerning RSRP measurements or other power or channel quality measurements.

In addition, the processor 704 is configured to command an RRH to transmit a reference signal (RS) to a UE that includes an PCI index for uniquely identifying the RRH from one or more other RRHs also controlled by base station 700. The processor 704 is further configured to, should the UE indicate that the reference signal has a suitable signal quality, command the RRH to transmit a control message to the UE that establishes a beam management relationship for the UE with the reference signal serving as a source reference signal for the beam management. For example, the control message may configure a downlink TCI state for the UE that includes a quasi-colocation (QCL) relationship between the reference signal (as identified through its PCI index and RS resource ID) and another downlink reference signal.

The processor 704 is responsible for managing the bus 702 and general processing, including the execution of software stored on the computer-readable medium 706. The software, when executed by the processor 704, causes the processing system 714 to perform the various functions described below for any particular apparatus. The computer-readable medium 706 and the memory 705 may also be used for storing data that is manipulated by the processor 704 when executing software.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706. The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

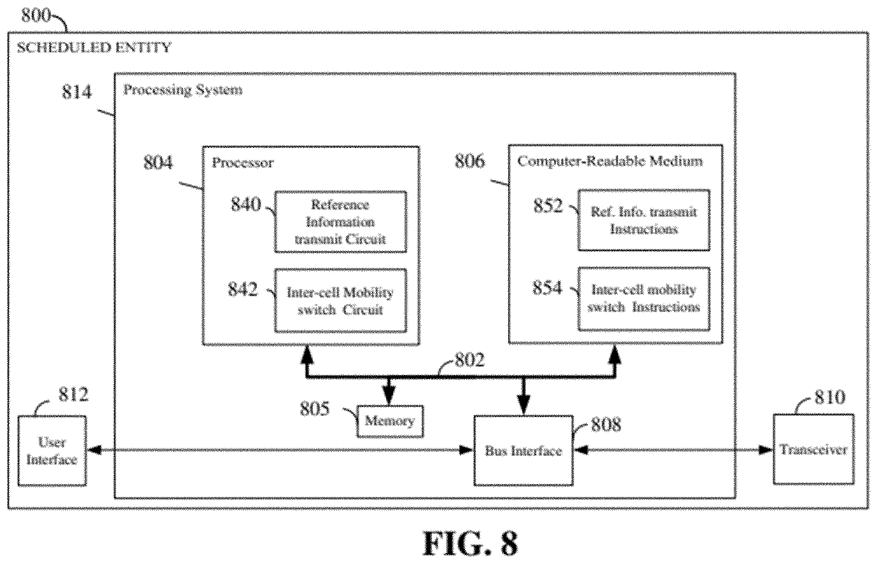

FIG. 8 is a conceptual diagram illustrating an example of a hardware implementation for an exemplary scheduled entity 800 employing a processing system 814. In accordance with various aspects of the disclosure, an element, or any portion of an element, or any combination of elements may be implemented with a processing system 814 that includes one or more processors 804. For example, the scheduled entity 800 may be a user equipment (UE) as illustrated in any one or more of FIGS. 1, 2, 3, and/or 6.

The processing system 814 may be substantially the same as the processing system 714 illustrated in FIG. 7, including a bus interface 808, a bus 802, memory 805, a processor 804, and a computer-readable medium 806. Furthermore, the scheduled entity 800 may include a user interface 812 and a transceiver 810 substantially similar to those described above in FIG. 7. That is, the processor 804, as utilized in a scheduled entity 800, may be used to implement one or more of the processes described previously in connection with the methodology disclosed in FIG. 6.

In some aspects of the disclosure, the processor 804 may include reference information transmit circuitry 840 configured for various functions, including, for example, transmitting reference information to the scheduling entity (e.g., 700). For example, the reference information transmit circuitry 840 may be configured to implement a function of determining or obtaining a power measurement such as RSRP and then causing transmission to a scheduling entity, gNB, or base station via transceiver 810. In other aspects of the disclosure, the processor 804 may also include an inter-cell mobility switch circuitry 842 configured for various functions including causing the scheduled entity 800 (e.g., a UE) to switch from a current serving cell to a selected cell based on the selection performed by circuitry 740 shown in FIG. 7 and also shown by block 606 in FIG. 6.

In other aspects, the computer-readable storage medium 806 may include reference information transmit instruction software 852 configured for various functions, including, for example, determining or obtaining a power measurement such as an RSRP and then causing transmission to a scheduling entity, gNB, or base station via transceiver 810. In one or more examples, the computer-readable storage medium 806 may include inter-cell mobility switch instruction software 854 configured for various functions, including, for example, causing the scheduled entity 800 (e.g., a UE) to switch from a current serving cell to a selected cell based on the selection performed by circuitry 740 shown in FIG. 7 and also shown by block 606 in FIG. 6.

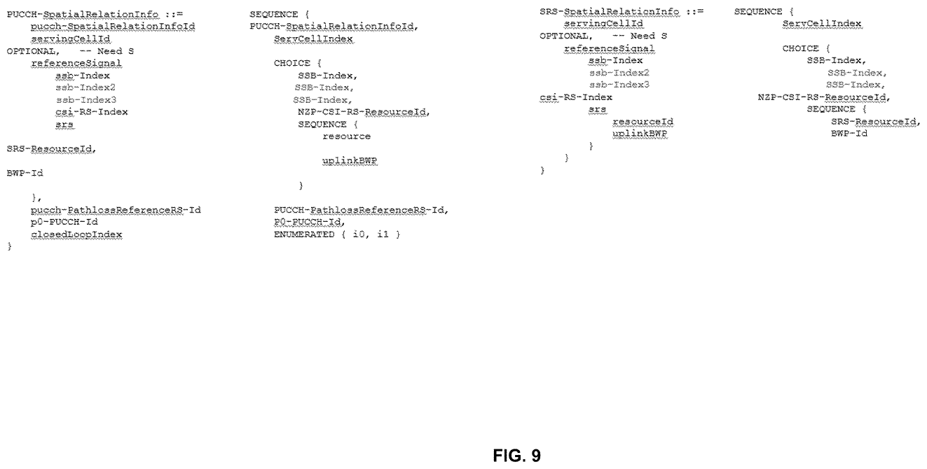

As discussed previously, a UE may transmit a PUCCH message that has a spatial relationship to a downlink reference signal such as an SSB from an RRH. This spatial relation may be configured through an RRC message transmitted to the UE. It was conventional that such an RRC message would identify the SSB through a field in the RRC message that includes the SSB index. But such an RRC message cannot uniquely identify the RRH source in a serving cell with multiple RRHs through merely the SSB index since each RRH in the serving cell may possess the full complement of the available SSB indices. To uniquely link the SSB as the source reference signal of the spatial relation, a modified RRC message is disclosed herein that includes a plurality of SSB indices. Each SSB index is associated with a unique PCI. An example PUCCH message is shown in FIG. 9. The PUCCH message includes a PUCCH-SpatialRelationInfo field that includes multiple SSB indices to identify a beam not only with an SSB ID (beam index) but also with a PCI index that uniquely identifies the RRH included in the spatial relationship. For example, the variable ssb-Index2 corresponds to the SSB ID associated with a second PCI index. Should there be multiple RRHs in a serving cell, a second one of the RRHs may be identified by a second PCI index that uniquely identifies this second RRH. Similarly, a variable ssb-Index3 corresponds to the SSB ID associated with a third PCI index that uniquely identifies a third RRH, and so on.

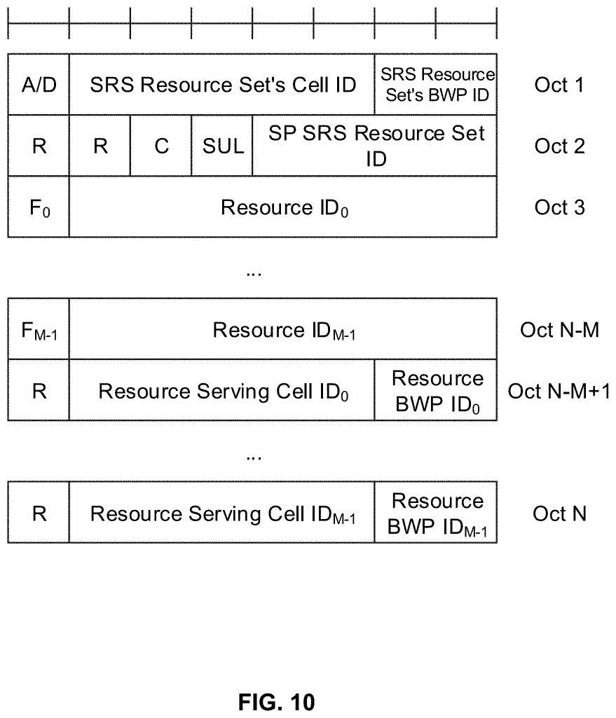

A layer 2 (MAC layer) message such as a MAC-CE may be transmitted to the UE to configure the beam management as also discussed previously. For example, the MAC-CE may configure the spatial relation for a UE. An example MAC-CE is shown in FIG. 10. The MAC-CE includes a plurality of M resource IDs ranging from a zeroth resource ID (Resource ID₀) to an (M−1)th resource ID (Resource ID_{M-1}). Each resource ID may provide a spatial relationship for a corresponding SRS resource. Each resource ID is also associated with a header F. For example, Resource ID0 is associated with a header F0, and so on. Should the header F be set to zero for a given resource ID in one implementation, a first bit of the resource ID may be set to one for the remainder of the resource ID contains the PCI index and the RS resource ID (for example, an SSB ID) for the RRH beam included in the spatial relationship. Referring again to FIG. 8, processor 804 is further configured to command for the transmission of the PUCCH message of FIG. 9 or the MAC-CE of FIG. 10.

The disclosure will now be summarized in the following example clauses:

Clause 1. A method for wireless communication comprising:
for a serving cell including a first remote radio head (RRH) and a second RRH, transmitting from the first RRH to a user equipment a first reference signal that includes a first PCI index for identifying the first RRH and a first reference signal (RS) resource ID; and transmitting from the second RRH to the user equipment a second reference signal that includes a second PCI index for identifying the second RRH and a second RS resource ID.
Clause 2. The method of clause 1, wherein the first reference signal comprises a first synchronization signal block (SSB) in which the first RS resource ID is a first SSB identification (ID), and wherein the second reference signal comprises a second SSB in which the second RS resource ID is a second SSB ID.
Clause 3. The method of clause 1, wherein the first reference signal comprises a first channel state information reference signal (CSI-RS) in which the first RS resource ID is a first CSI-RS resource ID, and wherein the second reference signal comprises a second CSI-RS in which the second RS resource ID is a second CSI-RS resource ID.
Clause 4. The method of any of clauses 1-3, further comprising:
from the first RRH, transmitting a control message to the user equipment to configure a downlink transmission configuration indicator (TCI) state for the user equipment, wherein the first reference signal is a source reference signal in a quasi-colocation (QCL) relationship established by the downlink TCI state, and wherein the QCL relationship is selected from the group consisting of QCL Type-A, QCL Type-B, QCL Type-C, and QCL Type-D.
Clause 5. The method of any of clauses 1-3, further comprising:

from the first RRH, transmitting a control message to the user equipment to configure a spatial relation for the user equipment;

wherein the first reference signal serves as a source reference signal for the spatial relation.

Clause 6. The method of any of clauses 1-3, further comprising:

from the first RRH, transmitting a control message to the user equipment to configure an uplink TCI state for the user equipment,

wherein the first reference signal serves as a source reference signal for the uplink TCI state.

Clause 7. The method of any of clause 2, wherein the first PCI index and the first RS resource ID are in separate fields in the SSB.
Clause 8. The method of clause 2, wherein the first PCI index and the first RS resource ID are jointly encoded into a single entry in the SSB.
Clause 9. The method of any of clauses 2, 7, and 8, wherein the first PCI index is a PCI having an integer value ranging from 0 to 1007.
Clause 10. The method of any of clauses 2, 7, and 8, wherein the first PCI index is an encoded version of a PCI.
Clause 11. The method of clause 5, wherein the control message is a medium access control element (MAC-CE) message that contains a resource ID field including the PCI index and the RS resource ID.
Clause 12. The method of clause 11, wherein the spatial relation is between the first reference signal and a Sounding Reference Signal (SRS) in a physical uplink control channel for the user equipment.
Clause 13. The method of clause 5, wherein the control message is a Radio Resource Control (RRC) message that includes a spatial relation field including a first SSB index associated with the first PCI index and a second SSB index associated with the second PCI index.
Clause 14. A base station, comprising:
a processor configured to: command a first RRH in a serving cell to transmit a first reference signal (RS) to a user equipment that includes a first PCI index for identifying the first RRH and a first RS resource ID; and command a second RRH in the serving cell to transmit a second reference signal to the user equipment that includes a second PCI index for identifying the second RRH and a second RS resource ID.
Clause 15. The base station of clause 14, wherein the processor is further configured to command the first RRH to transmit a control message to the user equipment to configure a downlink transmission configuration indicator (TCI) state for the user equipment, wherein the first reference signal is a source reference signal in a quasi-colocation (QCL) relationship established by the downlink TCI state, and wherein the QCL relationship is selected from the group consisting of QCL Type-A, QCL Type-B, QCL Type-C, and QCL Type-D.
Clause 16. The base station of clause 14, wherein the processor is further configured to command the first RRH to transmit a control message to the user equipment to configure a spatial relation for the user equipment, wherein the first reference signal serves as a source reference signal for the spatial relation.
Clause 17. The base station of clause 14, wherein the processor is further configured to command the first RRH to transmit a control message to the user equipment to configure an uplink TCI state for the user equipment,

wherein the first reference signal serves as a source reference signal for the uplink TCI state.

Clause 18. A method for wireless communication comprising:
receiving at a user equipment (UE) a first reference signal (RS) from a first remote radio head (RRH) in a serving cell, wherein the first reference signal includes a PCI index for identifying the first RRH and includes a first RS resource ID; and
receiving at the UE a second RS from a second RRH in the serving cell, wherein the second RS includes a second PCI index for identifying the second RRH and includes a second RS resource ID.
Clause 19. The method of clause 18, wherein the first reference signal comprises a first synchronization signal block (SSB) in which the first RS resource ID is a first SSB identification (ID), and wherein the second reference signal comprises a second SSB in which the second resource ID is a second SSB ID.
Clause 20. The method of clause 18, wherein the first reference signal comprises a first channel state information reference signal (CSI-RS) in which the first RS resource ID is a first CSI-RS resource ID, and wherein the second reference signal comprises a second CSI-RS in which the second RS resource ID is a second CSI-RS resource ID.
Clause 21. The method of any of clauses 18-20, further comprising:
receiving at the UE a control message from the first RRH; and
configuring a downlink transmission configuration indicator (TCI) state for the user equipment responsive to the control message, wherein the first reference signal is a source reference signal in a quasi-colocation (QCL) relationship established by the downlink TCI state, and wherein the QCL relationship is selected from the group consisting of QCL Type-A, QCL Type-B, QCL Type-C, and QCL Type-D.
Clause 22. The method of any of any of clauses 18-20, further comprising:
receiving at the UE a control message from the first RRH; and
configuring a spatial relation for the user equipment responsive to the control message, wherein the first reference signal serves as a source reference signal for the spatial relation.
Clause 23. The method of any of clauses 18-20, further comprising:
receiving at the UE a control message from the first RRH; and
configuring an uplink TCI state for the user equipment responsive to the control message, wherein the first reference signal serves as a source reference signal for the uplink TCI state.
Clause 24. The method of clause 22, wherein the control message is a medium access control element (MAC-CE) message that contains a resource ID field including the PCI index and the RS resource ID.
Clause 25. The method of clause 22, the control message is a Radio Resource Control (RRC) message that includes a spatial relation field including a first SSB index associated with the first PCI index and a second SSB index associated with the second PCI index.
Clause 26. A user equipment, comprising:
a transceiver configured to receive a first reference signal (RS) from a first remote radio head (RRH) in a serving cell, wherein the first reference signal includes a PCI index for identifying the first RRH and includes a first RS resource ID; and
receive a second RS from a second RRH in the serving cell, wherein the second RS includes a second PCI index for identifying the second RRH and includes a second RS resource ID.
Clause 27. The user equipment of clause 26, wherein the first reference signal comprises a first synchronization signal block (SSB) in which the first RS resource ID is a first SSB identification (ID), and wherein the second reference signal comprises a second SSB in which the second RS resource ID is a second SSB ID.
Clause 28. The user equipment of clause 26, wherein the transceiver is further configured to
receive a control message from the first RRH, the user equipment further comprising:
a processor configured to determine a downlink transmission configuration indicator (TCI) state for the user equipment responsive to the control message, wherein the first reference signal is a source reference signal in a quasi-colocation (QCL) relationship established by the downlink TCI state, and wherein the QCL relationship is selected from the group consisting of QCL Type-A, QCL Type-B, QCL Type-C, and QCL Type-D.
Clause 29. The user equipment of clause 26, wherein the transceiver is further configured to receive a control message from the first RRH, the user equipment further comprising: a processor configured to determine a spatial relation for the user equipment responsive to the control message, wherein the first reference signal serves as a source reference signal for the spatial relation.
Clause 30. The user equipment of clause 26, wherein the transceiver is further configured to receive a control message from the first RRH, the user equipment further comprising: a processor configured to an uplink TCI state for the user equipment responsive to the control message, wherein the first reference signal serves as a source reference signal for the uplink TCI state.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method for wireless communication comprising:
for a serving cell including a first remote radio head (RRH) and a second RRH, transmitting from the first RRH to a user equipment a first reference signal that includes a first PCI index for identifying the first RRH and a first reference signal (RS) resource identity (ID); and
transmitting from the second RRH to the user equipment a second reference signal that includes a second PCI index for identifying the second RRH and a second RS resource ID.

2. The method of claim 1, wherein the first reference signal comprises a first synchronization signal block (SSB) in which the first RS resource ID is a first SSB identification (ID), and wherein the second reference signal comprises a second SSB in which the second RS resource ID is a second SSB ID.

3. The method of claim 1, wherein the first reference signal comprises a first channel state information reference signal (CSI-RS) in which the first RS resource ID is a first CSI-RS resource ID, and wherein the second reference signal comprises a second CSI-RS in which the second RS resource ID is a second CSI-RS resource ID.

4. The method of claim 1, further comprising:
from the first RRH, transmitting a control message to the user equipment to configure a downlink transmission configuration indicator (TCI) state for the user equipment, wherein the first reference signal is a source reference signal in a quasi-colocation (QCL) relationship established by the downlink TCI state, and wherein the QCL relationship is selected from a group consisting of QCL Type-A, QCL Type-B, QCL Type-C, and QCL Type-D.

5. The method of claim 1, further comprising:
from the first RRH, transmitting a control message to the user equipment to configure a spatial relation for the user equipment;
wherein the first reference signal serves as a source reference signal for the spatial relation.

6. The method of claim 1, further comprising:
from the first RRH, transmitting a control message to the user equipment to configure an uplink TCI state for the user equipment,
wherein the first reference signal serves as a source reference signal for the uplink TCI state.

7. The method of claim 2, wherein the first PCI index and the first RS resource ID are in separate fields in the first SSB.

8. The method of claim 2, wherein the first PCI index and the first RS resource ID are jointly encoded into a single entry in the first SSB.

9. The method of claim 2, wherein the first PCI index is a PCI having an integer value ranging from 0 to 1007.

10. The method of claim 2, wherein the first PCI index is an encoded version of a PCI.

11. The method of claim 5, wherein the control message is a medium access control element (MAC-CE) message that contains a resource ID field including the first PCI index and the first RS resource ID.

12. The method of claim 11, wherein the spatial relation is between the first reference signal and a Sounding Reference Signal (SRS) in a physical uplink control channel for the user equipment.

13. The method of claim 5, wherein the control message is a Radio Resource Control (RRC) message that includes a spatial relation field including a first SSB index associated with the first PCI index and a second SSB index associated with the second PCI index.

14. A base station, comprising:
a processor configured to:
command a first RRH in a serving cell to transmit a first reference signal to a user equipment that includes a first PCI index for identifying the first RRH and a first reference signal (RS) resource identity (ID); and
command a second RRH in the serving cell to transmit a second reference signal to the user equipment that includes a second PCI index for identifying the second RRH and a second RS resource ID.

15. The base station of claim 14, wherein the processor is further configured to command the first RRH to transmit a control message to the user equipment to configure a downlink transmission configuration indicator (TCI) state for the user equipment, wherein the first reference signal is a source reference signal in a quasi-colocation (QCL) relationship established by the downlink TCI state, and wherein the QCL relationship is selected from a group consisting of QCL Type-A, QCL Type-B, QCL Type-C, and QCL Type-D.

16. The base station of claim 14, wherein the processor is further configured to command the first RRH to transmit a control message to the user equipment to configure a spatial relation for the user equipment, wherein the first reference signal serves as a source reference signal for the spatial relation.

17. The base station of claim 14, wherein the processor is further configured to command the first RRH to transmit a control message to the user equipment to configure an uplink TCI state for the user equipment,
wherein the first reference signal serves as a source reference signal for the uplink TCI state.

18. A method for wireless communication comprising:
receiving at a user equipment a first reference signal from a first remote radio head (RRH) in a serving cell, wherein the first reference signal includes a first PCI index for identifying the first RRH and includes a first reference signal (RS) resource identity (ID); and
receiving at the user equipment a second reference signal from a second RRH in the serving cell, wherein the second reference signal includes a second PCI index for identifying the second RRH and includes a second RS resource ID.

19. The method of claim 18, wherein the first reference signal comprises a first synchronization signal block (SSB) in which the first RS resource ID is a first SSB identification (ID), and wherein the second reference signal comprises a second SSB in which the second RS resource ID is a second SSB ID.

20. The method of claim 18, wherein the first reference signal comprises a first channel state information reference signal (CSI-RS) in which the first RS resource ID is a first CSI-RS resource ID, and wherein the second reference signal comprises a second CSI-RS in which the second RS resource ID is a second CSI-RS resource ID.

21. The method of claim 18, further comprising:
receiving at the user equipment a control message from the first RRH; and
configuring a downlink transmission configuration indicator (TCI) state for the user equipment responsive to the control message, wherein the first reference signal is a source reference signal in a quasi-colocation (QCL) relationship established by the downlink TCI state, and wherein the QCL relationship is selected from a group consisting of QCL Type-A, QCL Type-B, QCL Type-C, and QCL Type-D.

22. The method of claim 18, further comprising:
receiving at the user equipment a control message from the first RRH; and
configuring a spatial relation for the user equipment responsive to the control message, wherein the first reference signal serves as a source reference signal for the spatial relation.

23. The method of claim 18, further comprising:
receiving at the user equipment a control message from the first RRH; and
configuring an uplink TCI state for the user equipment responsive to the control message, wherein the first reference signal serves as a source reference signal for the uplink TCI state.

24. The method of claim 22, wherein the control message is a medium access control element (MAC-CE) message that contains a resource ID field including the first PCI index and the first RS resource ID.

25. The method of claim 22, the control message is a Radio Resource Control (RRC) message that includes a spatial relation field including a first SSB index associated with the first PCI index and a second SSB index associated with the second PCI index.

26. A user equipment, comprising:
a transceiver configured to receive a first reference signal from a first remote radio head (RRH) in a serving cell, wherein the first reference signal includes a PCI index for identifying the first RRH and includes a first reference signal (RS) resource identity (ID); and
receive a second reference signal from a second RRH in the serving cell, wherein the second reference signal includes a second PCI index for identifying the second RRH and includes a second RS resource ID.

27. The user equipment of claim 26, wherein the first reference signal comprises a first synchronization signal block (SSB) in which the first RS resource ID is a first SSB identification (ID), and wherein the second reference signal comprises a second SSB in which the second RS resource ID is a second SSB ID.

28. The user equipment of claim 26, wherein the transceiver is further configured to receive a control message from the first RRH, the user equipment further comprising:
a processor configured to determine a downlink transmission configuration indicator (TCI) state for the user equipment responsive to the control message, wherein the first reference signal is a source reference signal in a quasi-colocation (QCL) relationship established by the downlink TCI state, and wherein the QCL relationship is selected from a group consisting of QCL Type-A, QCL Type-B, QCL Type-C, and QCL Type-D.

29. The user equipment of claim 26, wherein the transceiver is further configured to receive a control message from the first RRH, the user equipment further comprising:
a processor configured to determine a spatial relation for the user equipment responsive to the control message, wherein the first reference signal serves as a source reference signal for the spatial relation.

30. The user equipment of claim 26, wherein the transceiver is further configured to receive a control message from the first RRH, the user equipment further comprising:
a processor configured to an uplink TCI state for the user equipment responsive to the control message, wherein the first reference signal serves as a source reference signal for the uplink TCI state.
